(19) United States
(12) Patent Application Publication
(10) Pub. No.: US 2006/0170645 A1
(43) Pub. Date: Aug. 3, 2006

(54) Active matrix display with a scanning backlight

(76) Inventors: Nebojsa Fisekovic, Eindhoven (NL); Martin Jacobus Johan Jak, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/549,378

(22) PCT Filed: Mar. 15, 2004
(86) PCT No.: PCT/IB04/50247

§ 371 Date: Sep. 14, 2005

(30) Foreign Application Priority Data
Mar. 17, 2003 (EP) 03100665.3

(51) Int. Cl. G09G 3/36

(52) U.S. Cl. 345/102

(57) ABSTRACT

The invention relates to an active matrix display system and a method of operating such a system. The system comprises an active matrix display panel and a scanning backlight including several light members (3a-e) each of which illuminates a pixel line or a sector of pixel lines, in a fully activated state (8) of high light intensity for a limited period of time when the pixel lines in that sector have been addressed (6a-e) according to a video signal and have reached a new fully or nearly fully modulated state. This is done to eliminate or reduce the tendency of the so called “Sample and Hold” artefact when displaying fast moving objects on the display. According to the invention the light members (3a-e) are not switched off completely during a time period between two successive fully activated states of high light intensity. Instead they are operated to a reduced, dimmed or glowing state (9) with low light intensity of 10-50%, preferably 15-40% and most preferred 20-30% of the high light intensity in the fully activated state to enhance brightness and reduce flicker of the display.

The present invention relates to an active matrix display system with a scanning backlight, for example an active matrix LCD-system for use in a TV set or in a monitor.

The invention also relates to a method of operating such an active matrix display system.

One of the most important requirements a display has to meet in order to be used for video applications is to provide sharp motion pictures. Nevertheless, motion pictures shown on an active matrix display, e.g. an active matrix LCD (Liquid Crystal Display) panel, loose their sharpness and become blurred when displaying fast moving objects even when very fast LCD panels are used. The reason for this is that the motion blur is not caused by the speed of the pixels (picture elements) only. It is also caused by the combination of the hold characteristics of the display since each line of pixels is modulated once in a modulating cycle or frame time and thereafter transmits light continuously from a backlight until the next modulating cycle, and the characteristics of the human eye trying to follow the motion. This effect is known as the “Sample and Hold” artefact and it is not limited to active matrix LC-displays only. Every active matrix display suffers from the same problem.

The most efficient method for removing the “Sample and Hold” artefact in active matrix display panels is the use of so called scanning backlight, i.e. displays which are operated not to emit light continuously but in short time pulses. The pulsed light exposure of each pixel should be carried out once in a frame time and not before the pixel has reached its desired transmission level, i.e. when the pixel has been addressed and has reached a new fully or near fully modulated state. Because the active matrix display panel is addressed line by line, this moment in time is different for every line. Therefore, it is necessary to use scanning backlight which is synchronized with the video signal. Such backlight produces a horizontal band of light of a certain width that scans vertically over the panel. Due to the stroboscopic effect of the backlight, the object is seen only at the right moments when the pixel lines in question just have been modulated, which yields a sharp perceived image.

The method according to scanning backlight does not demand fast pixel response and it enables removing of the motion blur artefact effectively. It enables a perfect motion portrayal with a pixel response time that lies just within a frame time (˜16 ms for 60 Hz frame rate and ˜20 ms for 50 Hz frame rate). No extensive signal processing is required either.

There are several other methods known in the art to remove or at least reduce the “Sample and Hold” artefact, but scanning backlight has proved to be the only method which is able to remove the “Sample and Hold” effect completely. Also, the dynamic contrast and colour purity are increased when this method is used, which makes the use of scanning backlight the most beneficial method for removing the “Sample and Hold” artefact.

However, scanning backlight has also some disadvantages. The most important one is the loss of brightness. Decreasing the exposure time of the pixels decreases the amount of the light which they emit, making the picture darker. The brightness decrease is proportional to the duty cycle of the backlight, i.e. the time ratio between “on” and “off” states of each pixel.

Another disadvantage of the scanning backlight method is appearance of flicker. Due to the stroboscopic nature of the backlight, observer has an impression that the whole display blinks with the frequency of the frame rate.

As an example of a prior art scanning backlight device and method, reference is made to WO 9501701 A.

It is an object of the invention to provide an active matrix display system with an improved scanning backlight. More precisely it is an object to enhance the brightness and remove the tendency of flicker for an active matrix display system provided with a scanning backlight. At least this object is achieved by an active matrix display system according to claim 1.

The invention also relates to a method of operating an active matrix display system provided with a scanning backlight, with essentially the same object as above. This object is achieved by a method according to claim 5.

The invention is thus based on the understanding that the brightness may be enhanced and the tendency of flicker may be removed and yet yield a sharp perceived image with removed or at least reduced “Sample and Hold” artefact, by driving the scanning backlight such that the light is not completely switched off in the time period between two modulating operations of the lines of pixels. Instead the backlight is caused to be dimmed or glow with low intensity in the time period between two modulating operations of the pixels. Since the brightness is a function of the average light intensity during a time period, it is evident that the brightness is increased if the lowest light intensity level is increased from 0% to between 10-50%, preferably to between 15-40% and most preferred to between 20-30% of the maximum light intensity. Also, the flicker is reduced as the difference between the maximum and the minimum light intensity is decreased. Yet, the low intensity back light is reduced to such an extent that the image is not deteriorated since details of the picture is not actually perceived during the period with low light intensity. Accordingly, the display is able to provide sharp motion pictures without any “Sample and Hold” artefact.

In an active matrix display provided with a scanning backlight according to the invention, each line of pixels may be illuminated by a separate light member. However, since e.g. an active matrix LCD-display normally contains more than 1000 lines, such a solution would result in a complicated and hence expensive display. Usually, an acceptably performance of the display, may be achieved by providing a light member for e.g. every 50 to 150 lines of pixels and consequently normally about 7 to 12 light members for each display.

The light members may be operated in sequence, so that only one light member is in its fully activated state with high light intensity at each time. I.e. one light member is reduced from its high light intensity to its reduced or dimmed state with low light intensity simultaneously with activating the subsequent light member to its high light intensity state. Normally however, the light members are activated with some overlap so that two or more light members are in their fully activated states of high light intensity simultaneously.

All translucent active matrix displays, i.e. displays with a backlight, can use the scanning backlight according to'the present invention for removing the motion artefacts, and the described improvement of the scanning backlight driving method, according to the present invention, can be applied to all systems where a scanning backlight system is applied.

Furthermore, with a scanning backlight according to the invention, there is electric current flowing through the light members all the time. Therefore it is not necessary to re-ignite the light members in the backlight every time their fully activated period comes. This makes driving of the light members much easier and construction of inverters for their driving simpler. The fact that re-ignition of the light members is not necessary at the beginning of every fully activated period, increases the life time of the light members in comparison to the ordinary backlight. When the light members are completely switched off during the period between two consecutive fully activated periods, like in ordinary scanning backlight, their temperature is lower than the optimal working temperature because they cool down during the inactivated period when they are switched off. With the proposed driving method the temperature of the light members is higher due to the current which constantly flows through them, i.e. the temperature is closer to the optimum working temperature.

The present invention involves a compromise between the increase of the display light output and the efficiency of motion artefact suppression. Nevertheless, experiments show that it is possible to introduce the proposed bias of the light members to a minimum light intensity and achieve substantial brightness increase without a noticeable degradation of motion picture quality.

These and other aspects of the invention will be apparent from and elucidated with reference to the embodiment described hereinafter.

The invention will now be explained by way of example with reference to the accompanying drawings in which:

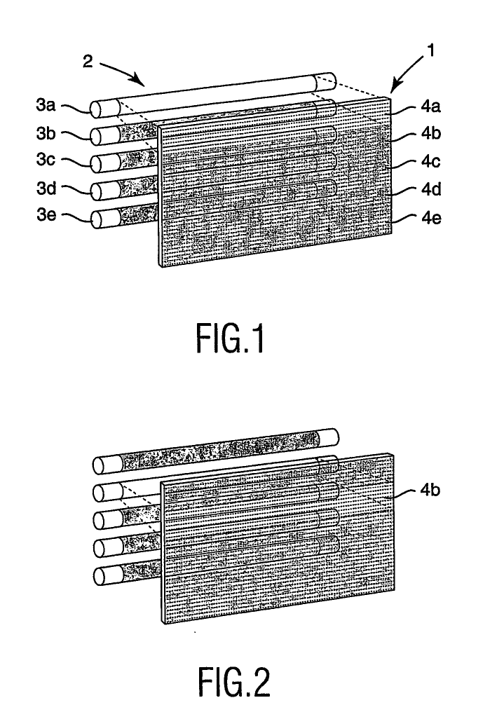

FIG. 1 is a diagrammatic exploded perspective view of an active matrix display panel and a scanning backlight with the uppermost light member in a fully activated state of high light intensity;

FIG. 2 is a view similar to FIG. 1 but with the second uppermost light member in a fully activated state; and

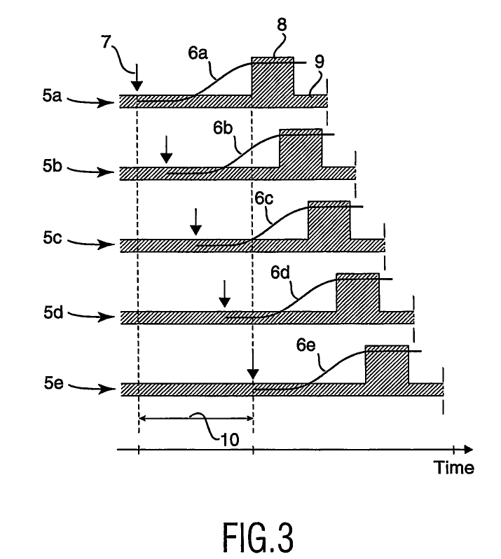

FIG. 3 is a timing diagram illustrating the sequential addressing of the lines of pixels and the activating rate of the light members, respectively, in time sequence.

In the drawing is shown a preferred embodiment of an active matrix display panel 1, e.g. an active matrix LCD-display panel, provided with a scanning backlight 2. The display panel includes a large number of pixels arranged in normally more than one thousand horizontal lines of pixels. Each pixel may be continuously variable in a desired degree from substantially a none-translucent to a maximum translucent state. This is done electrically by addressing the pixels line by line several times per second, normally 50 or 60 times per second. When the pixels are in a translucent state, they are capable of transmitting light from the scanning backlight to a desired extent which creates an image that a viewer in front of the display can see. By changing the image in small steps and short time intervals, it is created an illusion of a continuously moving picture.

The scanning backlight 2 in the figures comprises, for the sake of simplicity, five separate light members 3a-e, but it should be understood that many more light members may form part of a display system according to the invention. Each light member is adapted to illuminate a horizontal sector 4a-e, including several pixel lines, from the back of the display panel. This is not done until every pixel in a sector has been modulated by an addressing signal and each pixel has reached its fully or near fully modulated state.

According to the principle of scanning backlight, the light members 3a-e will in sequence illuminate their allocated sector from the back of the display panel. Thus, in FIG. 1, the uppermost light member 3a is fully activated at high light intensity and illuminates an uppermost sector 4a of the display panel, in which each pixel has been modulated to the desired translucent state. When all the pixels in the subsequent sector 4b of the display panel has been addressed and modulated, the uppermost light member is brought into a reduced state of low light intensity while, slightly before that, the second uppermost light member 3b is fully activated to illuminate the back of the second uppermost sector of the display panel, as is illustrated in FIG. 2. In the same way, the rest of the display panel is illuminated, sector after sector, until the whole display panel has been illuminated in a frame time, whereafter the process starts all over again with the uppermost sector and light member.

The process is illustrated in the timing diagram of FIG. 3, in which 5a-e discloses the variation of the light intensity between the reduced and the fully activated state of the light members 3a-e , and 6a-e discloses the variation of the modulation rates of the pixels in each sector 4a-e at each point of time during the frame cycle. As mentioned before, each pixel line is addressed in sequence at different points of time. Since each sector 4a-e contains several pixel lines, this means that the pixel lines in each sector are addressed at different points of time as well. Consequently, the graphs 6a-e are illustrations of the addressing and modulating of the last pixel line in each sector, whereas the rest of the pixel lines in the same sector are somewhat ahead in respect of time.

Each sector, that is to say the last pixel line in each sector, is addressed at a point of time marked by an arrow 7, by an addressing signal from an addressing system according to a video signal. The graphs 6a-e illustrate how the pixels in each sector goes from an unchanged or none modulated state in relation to a preceding addressing and modulation, to a new fully modulated state. This modulating time may vary in dependence of how fast the pixels are. When the pixels in one sector has reached, or is close to, a fully modulated state, the light member for that specific sector is fully activated to shine with high light intensity, as illustrated by an upward directed rectangular block 8.

The pixels remain in the same modulated state until the subsequent addressing signal. As illustrated in the drawing, a fully activated light member is brought to the reduced state with a somewhat overlap in respect of the subsequent light member when the last pixel line in that sector has reached a fully or nearly fully modulated state, i.e. two adjacent light members are fully activated simultaneously for a short period of time.

However, according to the invention, when the light members are reduced, they are not switched off completely. Instead their light intensity is reduced to a dimmed or glowing state with a light intensity that is 10-50%, preferably 15-40% and most preferably 20-30% of the high light intensity in the fully activated state. This is illustrated in FIG. 3 by a horizontally extended strip 9 which defines a low light intensity of the light members in the reduced state in the period between two successive high light intensity periods 8. The numeral 10 in FIG. 3 denotes a frame time between the addressing of the first and last pixel line of the display.

In summary the invention relates to an active matrix display system and a method of operating such a system. The system comprises an active matrix display panel and a scanning backlight including several light members 3a-e, each of which illuminates a pixel line or a sector of pixel lines, in a fully activated state 8 of high light intensity for a limited period of time when the pixel lines in that sector have been addressed 6a-e according to a video signal and have reached a new fully or nearly fully modulated state. This is done to eliminate or reduce the tendency of the so called “Sample and Hold” artefact when displaying fast moving objects on the display. According to the invention the light members 3a-e are not switched off completely during a time period between two successive fully activated states of high light intensity. Instead they are operated to a reduced, dimmed or glowing state 9 with low light intensity of 10-50%, preferably 15-40% and most preferred 20-30% of the high light intensity in the fully activated state to enhance brightness and reduce flicker of the display.

1. An active matrix display system comprising a display panel having lines of picture elements for modulating light, which are separately drivable in a continuously variable manner between a maximum translucent state and a substantially non-translucent state, several light members for illuminating the display panel from a rear side to produce a display output in accordance with the degree of translucency of each picture element, an addressing system for addressing the lines of picture elements sequentially to a desired translucent state of each picture element according to a video signal, and a driving system for driving each light member in a fully activated state of high light intensity for a limited period of time to selectively illuminate one or more lines of picture elements at a time, synchronous with the addressing system, when each pixel has reached its fully or near fully modulated state, characterised in that the light members Fin the time period between two consecutive fully activated states, are operated to a reduced state of low light intensity.

2. An active matrix system according to claim 1, characterised in that the light intensity of the light members in the reduced state is between 10% and 50% of the light intensity in the fully activated state.

3. An active matrix system according to claim 1, characterised in that the light intensity of the light members in the reduced state is between 15% and 40% of the light intensity in the fully activated state.

4. An active matrix system according to claim 1, characterised in that the light intensity of the light members in the reduced state is between 20% and 30% of the light intensity in the fully activated state.

5. A method of operating an active matrix display system, comprising a display panel having lines of picture elements for modulating light, several light members on a rear side of the panel, an addressing system for addressing the picture elements, and a driving system for driving the light members in a fully activated state of high light intensity, the method comprising the steps of modulating the picture elements by means of the addressing system in a continuously variable manner to a desired degree between a maximum translucent state and a substantially non-translucent state by modulating the picture elements sequentially line after line in accordance with a video signal, to selectively illuminate one or more lines of picture elements at a time in the fully activated state for a limited period of time, from the rear side of the display panel, synchronous with the addressing system, to produce a display output in accordance with the degree of translucency of each picture element, characterised by the further step to drive the light members (3a-e) in a reduced state of low light intensity during a time period between two consecutive fully activated states.

6. A method according to claim 5, characterised by driving the light members such that the light intensity in the reduced state is between 10% and 50% of the light intensity in the fully activated state.

7. A method according to claim 5, characterised by driving the light members such that the light intensity in the reduced state is between 15% and 40% of the light intensity in the fully activated state.

8. A method according to claim 5, characterised by driving the light members such that the light intensity in the reduced state is between20% and 30% of the light intensity in the fully activated state.
